(19) United States
(12) Patent Application Publication
(10) Pub. No.: US 2016/0008107 A1
(43) Pub. Date: Jan. 14, 2016

(54) BITE FORK WITH RECESSES

(71) Applicant: ZEBRIS MEDICAL GMBH, Isny (DE)

(72) Inventor: Wolfgang BRUNNER, Isny (DE)

(21) Appl. No.: 14/772,396

(22) PCT Filed: Jan. 22, 2014
(86) PCT No.: PCT/DE2014/200021

§ 371 Date: Sep. 3, 2015

(30) Foreign Application Priority Data
Mar. 4, 2013 (DE) 10 2013 203 597.7
Mar. 12, 2013 (DE) 10 2013 204 207.8

(51) Int. Cl. A61C 9/00; A61C 19/045

(52) U.S. Cl. CPC A61C 9/0006; A61C 9/004; A61C 19/045

(57) ABSTRACT

Bite fork for check-bite, especially with position marker elements for position determination in a position determination system, wherein the bite fork comprises recesses at the contact surface for partial visualization of the tooth surface to an image sensor placed into the mouth cavity of a patient and markers, which are detectable by said sensor.

The invention relates to a bite fork (also called a bite plate) for receiving a molding compound or a check-bite registration material, in particular with position marker elements for positioning in a positioning system, and a check-bite kit. Furthermore, it relates to a method and a system for displaying a dentition, in which such a bite fork may be employed.

Bite forks are well known working means in dental medicine, by means of which imprints of the tooth surfaces are taken, and can be further processed, in particular for the production of dental models. Commonly, they are one-piece plastic parts, which have been known in various forms of design. These plastic parts are filled or occupied with a so-called registration material (check-bite registration material), into which the tooth surfaces of the patient imprint as a so-called impression memorize entry when the bite fork is inserted into him and he bites into the check-bite registration material.

In connection with various dentist services, especially with provision of high-quality partial or full dentures or splints, display and animation of virtual tooth surfaces in computer units is desirable. For this purpose, a positioning system and a specially designed bite fork for use in the same have been proposed by the applicant in DE102 18 435 B4. The bite fork has an extension on which a holding device for position sensors or markers of the positioning system (e.g. ultrasound markers) can be attached. A more elaborate bite fork of this kind is also described in the unpublished document PCT/EP2011/058790 of the applicant. At that bite fork, an X-ray marker configuration is firmly attached or attachable.

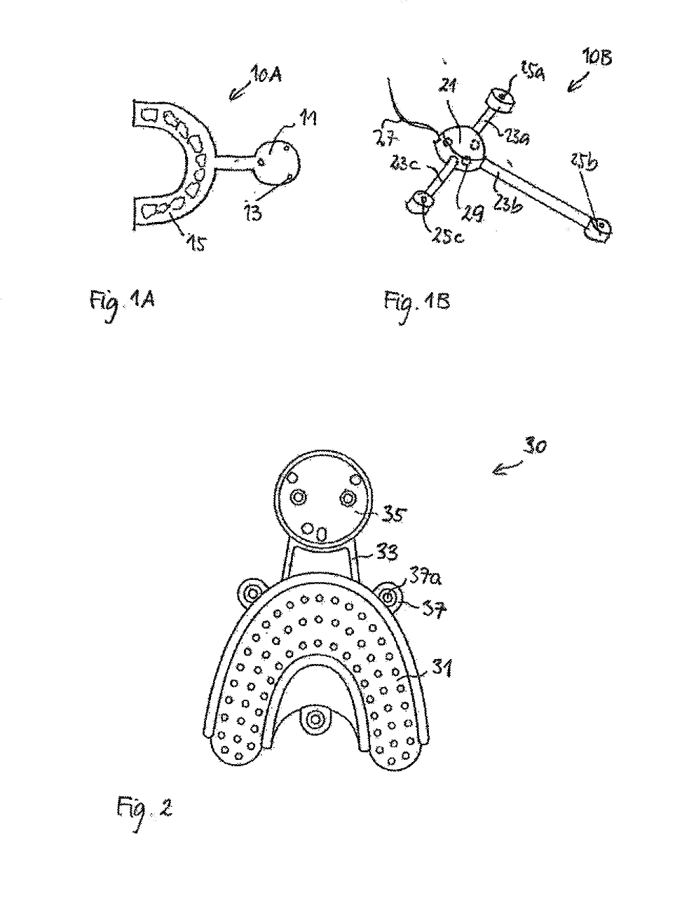

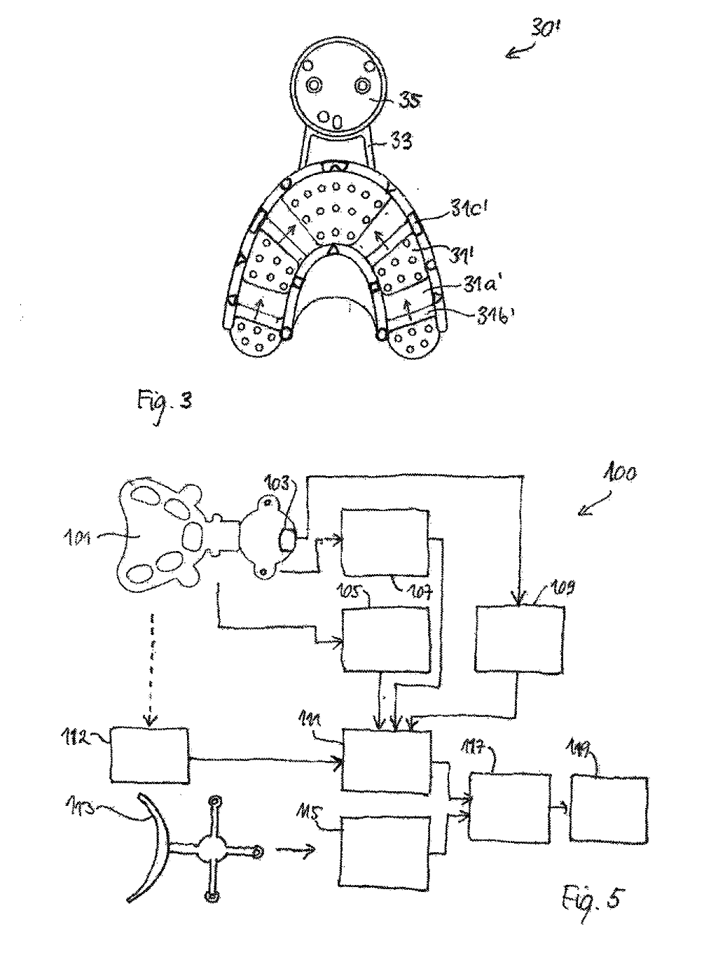

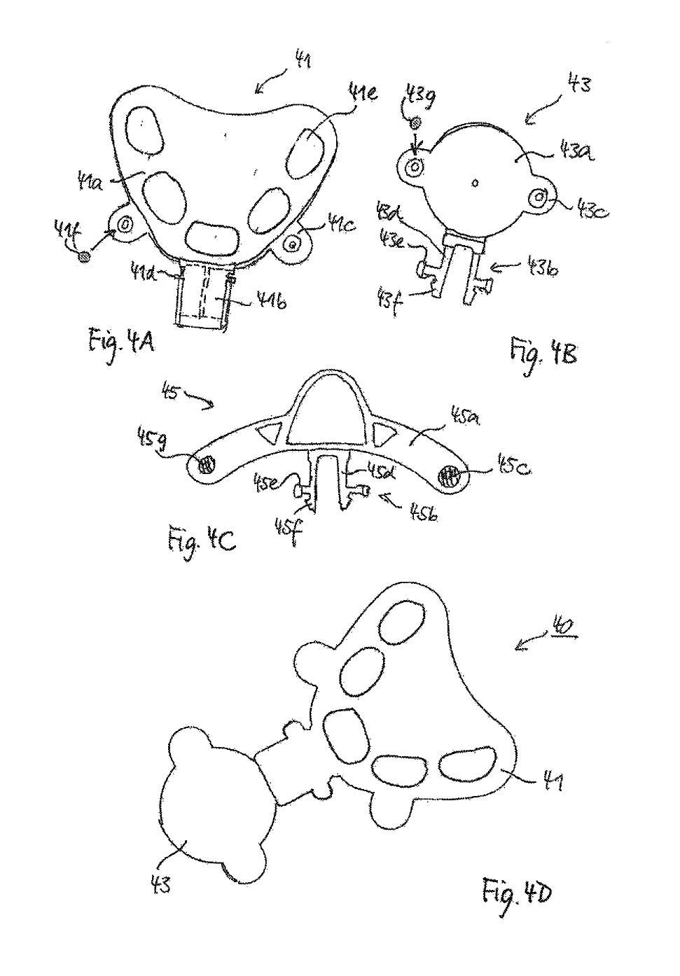

FIG. 1a is a scheme of a check check-bite part 10A of the first known bite fork with a projection 11 on which a metal retaining disk with three locking holes 13 and a recording material (bite registration) 15, into which into the footprints of tooth surfaces are stamped, is provided.

FIG. 1b shows a position marker section 10B of the bite fork, that has a disc-shaped central part 21, and three arms 23a, 23b and 23c are provided on it, at the ends of which a position marker 25a, 25b and 25c, respectively, is located. In other configurations the position markers are arranged on an arched body. In the illustrated configuration, a cable 27 for supplying power to the position markers configured as active elements is provided; however, the position markers may also be passive and do not require a power supply, and consequently no connecting cable. The middle part 21 is designed for attachment to the circular part of the extension 11 of the check-check-bite part of FIG. 1A by way of small balls 29 latching into the latching openings 13 of the check-bite part. In the holding part 21 a magnet, which connects to the holding plate of the check-bite part, is provided. The arrangement of the balls and the magnet can also be performed on the check-bite part, wherein the retaining plate 13 is then attached to the position marker part. In a further configuration, the position marker part may be attached to the check-bite part by mechanical locking means.

FIG. 2 shows another bite fork 30, which basically is similar to the configuration shown in FIG. 1, which herein is shown without bite registration material and dental impressions. Here, an extension 33 is also provided on the fork to plate-shaped base body 31, which widens to a circular plate 35 onto which a separately manufactured position marker configuration shown to FIG. 2 or the like may be attached. In this respect, the bite fork shown may also be considered as part of a more complex bite-fork or bit-fork arrangement, respectively, to which furthermore at least one sensor part belongs. In addition, the bite fork 30 has smaller extensions 37 provided thereto with holding points 37a for insertion of X-ray markers.

In DE 20 2011 105 953.0 of the applicant, improvement of the above-described bite forks, the core of which consists of a two-part design is described.

In recent years, detection of the tooth surfaces and overall geometry of the mouth internal cavity of patients using intraoral scanners has become more and more important. The images of the tooth surfaces and of the mouth cavity, respectively, acquired by such scanners are not readily adaptable for an animation and simulation of movements of the dentition.

Previously used bite forks are suitable for establishing the relation of extraoral scanners and the measured surfaces of tooth models to the position measuring systems. On the other hand, partial tooth surfaces, which are determined directly in the mouth by intraoral 3D surface scanners, cannot be easily correlated with position measuring systems. Furthermore, with intraoral scanners, large sections of the dental arch or the entire arch of the upper or lower jaw cannot be detected with high accuracy, because each of the relatively small tooth surfaces is determined and they must be matched to a large matching surface. In doing this, positioning errors add up accordingly.

The object of the invention is to provide an improved bite fork or bite plate, respectively, which offers improved diagnostic evidencing capabilities, especially with the use of new techniques in dental diagnostics.

This object is achieved by a bite fork having the features of claim 1. Furthermore, a check-bite kit having the features of claim 10 is provided. Furthermore, a system for moving image representation of teeth, comprising the features of claim 11, and an imaging process of the natural dentition having the features of claim 14 is provided. Suitable configurations of the inventive idea are the object the respective subclaims.

According to the invention the bite fork comprises recesses on the contact surface for partial visualization of the tooth surfaces for the detection of the tooth surface via an intraoral 3D surface scanner, and marker elements which are detectable by this this sensor. It thus is collectively and simultaneously employable with an intraoral scanner. In a preferred embodiment, the bite fork has a position marker part for obtaining “absolute” position data to be linked to these 3D image data. Instead of or in addition to a position marker part, besides the plug-on part having a position sensor, another sensor system may be provided that may provide additional data for the production of qualitatively or esthetically improved dental prostheses, respectively. The realization of the invention is also possible with a simple bite fork or bite plate without any sensor system.

The bite fork according to the invention enables relation between the measurement data from intraoral 3D surface scanners and the data of SD positioning systems and, at the same time, to detect tooth surfaces or the entire dental arch with high accuracy so as to be able to display the surfaces statically as well as in motion with high precision. This enables improved diagnostic statements as well as improved simulation options for force transmission and collision check during the manufacture of dentures in prosthetics and implantology.

In embodiments of the invention, the bite fork includes adjustment means for variably setting the opening portion of at least a portion of the recesses. In one embodiment, the adjustment means have displaceable bars which are designed such that they can connect an external rim region to an internal rim region or central region of the bite fork at different points of the extension thereof to each other. This design and configuration, with various methods (scanning or acquiring image impression) allows variable data of different tooth surfaces or teeth portions to be acquired and to be provided for combined evaluation. Optionally, the proposed adjustment means (specifically movable bars) may also be configured as being individually removable.

In a further embodiment, it is provided that at least one part of the marker elements is designed as a characteristic, optical or 3D detectable positive casts or impressions or optical or 3D-contrast markers, in particular as a series of positive casts or impressions or contrast markers, in one rim region or both rim regions of the is bite fork. In this embodiment, an intraoral 3D surface scanner, besides data of the tooth or jaw surface, at the same time acquires reference data for the combination of the bite fork preferably fixed by means of molding compound. However, this reference is basically to be realized also with other types of marker elements.

For example, at least part of the marker elements may be configured as radiopaque elements, which are attached to a base body of the bite fork or are embedded into the base body, the reference required is then produced by means of an X-ray image.

In another embodiment, the bite fork comprises a check-bite part having first attachment means and a position matter part or sensor part having second attachment means matching the first attachment means, which is releasably connected to the check bite part.

The configuration of the bite fork with a removable position marker part, on the one hand, provides for advantage in handling because the actual check-bite part is less bulky than the bite forks described above and does not interfere even with complex check-bite and positioning configurations involving maxillary and mandibular components. In particular, the position sensor may be placed onto the attachment attached to mandibular teeth, without causing spatial collision to the bite fork.

The proposed design increases applicabilities in that different position marker components may directly be added to the check-bite part without having to make efforts in material and logistics for the provision of complete bite forks.

In one aspect of this configuration, the first and second attachment means form and include first and second contact surfaces, respectively, which, in the connected state of the check-bite part and position marker part, abut against each other, thus defining a predetermined distinct position of the position marker part with respect to the bite marker part.

The proposed check-bite kit for the formation of different bite forks of the above-described type is characterized in that in addition to a check-bite part according to the invention multiple removable position marker parts or other accessory components (e.g. an apparatus for the determination of the facial symmetry) are provided with second attachment means matching the first attachment means (at the check-bite part).

The dental diagnostic system proposed according to a further aspect of the invention, in addition to a bite fork of the type set forth above, includes tooth surface detection means for providing an image of at least part of the tooth surfaces of the dentition, first position detection elements matching the position marker elements of the bite fork for position detection of the bite fork in the state of being inserted in the mouth of an individual, first processing means for correlating the image of the tooth surfaces and the position data of the bite fork for providing a spatial coordinate-accurate image of the tooth surfaces, one paraocclusal spoon to be attached to the teeth, having other position marker elements, second position detection means matching the further position marker elements for continuous position detection of the paraocclusal spoon during movements of the dentition and second processing means for the creation of the moving image representation of the dentition according to the image of the tooth surfaces in accordance with the spatial coordinates and the time-dependent position data of the paraocclusal spoon.

In a suitable embodiment, the tooth surface detection means are realized by an intraoral scanner, wherein the bite fork has markers, which are optically detectable by the scanner. In an alternative embodiment, the tooth surface detection means are realized by an X-ray image sensor, and radiopaque markers are provided at the bite fork.

In another embodiment, in an outermost mouth section of the bite fork, face surface detecting means for providing an image of at least one portion of the face of the individual are provided. The first processing means are then designed for correlating the image of the face surface with the position data of the bite fork and to provide an image of the face surface, and the second processing means are designed for providing a moving image representation of the face of the individual.

In configurations attainable with commercially available electronic components in a cost-effective manner, the position marker elements of the bite fork and/or the other position marker elements of the paraocclusal spoon have ultrasound markers, optical markers or marker elements, which are detectable by way of magnetic sensors.

Features of the method of the invention for imaging a dentition essentially directly arise from the system aspects of the invention set forth above and will not be repeatedly explained herein. However, it is to be noted that both under procedural and systemic aspects a moving image representation may advantageously be created by means of the bite fork according to the invention, but the scope of the invention is not limited thereto. Conventional methods for the production of dental prostheses may also benefit from the advantages of employing the bite plate according to the invention and the combined evaluation of 3D surfaces directly recorded in the patient's mouth. For example, certain problems that may occur with intraoral 3D scanners during imaging an entire dental arch can be corrected by way of the impressions taken with the bite fork of the invention. Additional benefits and advantages of the invention will become apparent from the following description of executive examples, wherein reference is made to the figures, wherein:

FIGS. 1A and 1B are schematic representations of a known bite fork in plan view,

FIG. 2 is a representation of a known bite plate in plan view,

FIG. 3 is a representation of a bite plate according to the invention based on the bite plate of FIG. 2,

FIGS. 4A to 4D are representations of a further embodiment of the bite fork of the invention, and

FIG. 5 is a schematic representation of an embodiment of a system according to the invention for motion picture representation of a dentition.

FIG. 3 shows a bite fork 30′, in the base body of which multiple openings 31a′ are provided, which each are associated to a rib 31b′ maintained at each one of the outer and inner rim of the bite fork. The openings 31a′ in turn serve to visualize areas of tooth or jaw surfaces to an intraoral scanner, and by means of the sliding ribs 31b′ the appropriate image section is allowed to be variably adjusted. The figure shows only an exemplary configuration of the openings and ribs, of which multiple variations are possible. Thus, almost the entire contact surface of the registration may exclusively be formed by the slidable (then preferably wider) ribs and a virtually free selection of the exposed surface area of the teeth and the jaw may be taken, respectively. Prominent extensions 31c′ on the inner and outer rim of the base body 31′ (shown in the figure with various shapes, but are collectively referred to by number 31c′) serve as optical marker elements for optical image detection of the mouth cavity, as a reference for a position assignment in the context of image processing.

FIGS. 4A to 4C show a check-bite part 41 (FIG. 4A) and two different position marker parts 43 (FIG. 4B) and 45 (FIG. 4C) of a bite fork 40, respectively, which has or may accommodate position marker elements for positioning in a positioning system and is outlined in a possible configuration in FIG. 4D.

The check-bite part 41 includes a fork-shaped up to plate-shaped base body 41a onto which a short clamp-like extension 41b is provided, forming first attachment means of the bite fork 40, which is designed by attaching one of the position marker parts 43 or 45 according to FIG. 4B or 4C. The base body 41a of the check-bite part 41 has a plurality of openings 41e, which are spared even when filling the check-bite part with registration material, thus leaving tooth or jaw surface sections placed at the appropriate sites visible in the inserted state of the bite fork. These sections are then ready for detection by an intraoral scanner. Basically, the recesses 41e may be significantly larger and may encompass the entire tooth surface, thus leaving only an outer rim for receiving and fixing the markers to the tooth surfaces.

Both position marker parts, at a disc-shaped base body 43a or arc-shaped base body 45a, have second attachment means 43b and 45b, respectively, corresponding to the first attachment means 41b of the check-bite part. In the illustrated embodiment, both the check-bite part 41 and the position marker parts have accommodations to accommodate position markers, i.e. as extensions 41c and 43c at the respective base body of the check-bite part 41 and the position marker part 43, respectively, or as impressions 45c at the free ends of the arc-shaped base body 45a of the position marker part 45. In each figure, a spherical X-ray marker 41f and 43g, respectively, is shown by an arrow adjacent to one of the extensions, in order to make clear that it may be clamped thereto. It is also possible to produce the check-bite part and the position marker part with fixedly inserted position markers, for example the cast-in position markers 45g in FIG. 4C.

The second attachment means 43b and 45b are also configured in a clamp-like manner with two legs 43d, which together fit into recesses formed by the legs of the first clamp-like attachment means 41b at the check-bite part 41. At each of the legs 43d and 45d, respectively, extensions 43e and 45e are provided which serve as a handling for ease of compression of the legs for the insertion into the mounting bracket 41b at the check-bite part or for removal therefrom.

Small barbs 43f and 45f at the free ends of the legs 43d and 45d, respectively, slidably pass ribs 41d which are provided on the outer edges of the bracket 41b (perpendicularly extending to the plane of the two bracket legs), during insertion of the respective position marker part into the check-bite part, thus latching the respective position marker part to the check-bite part by way of the legs of the second attachment means, after having passed the ribs, slightly spreading behind them and thus anchoring. This anchoring is released by compressing the legs by handlings 43e and 45e, respectively, and the barbs may pass the ribs 41d and slide back for removing the position marker part from the check-bite part.

Modifications of the configurations set forth above are for example possible in that those openings (recesses) in the material of the bite fork—and hence in the registration material—are only provided at the left- or right-hand part. Even a configuration generally only designed as a “half-sided” bite plate may be provided with openings or recesses, respectively, for directly acquiring the tooth surfaces by way of a scanner.

FIG. 5 as a scheme, shows essential parts of a system 100 for moving image detection/display of the dentition of a patient or individual, comprising a bite fork of the type described above. Such a bite fork, herein referred to as reference number 101, in the illustrated system configuration, at the outermost section of the mouth (position marker part), has a camera 103 for acquiring the face surface of a patient. The system includes a tooth surface detection unit 105, which intraorally detects at least sections of the dental surfaces of the patient, and a position detection unit 107, which analyses the position signals of the position markers of the bite fork 101. The dental surface detection unit 105 may be realized by way of an intraoral 3D surface scanner. A camera image processing unit 109 performs pre-processing of the image of the face captured by the camera 103.

The output data of the tooth surface detecting unit 105 and the position detection unit 107 as well as the camera image processing unit 109 enter inputs of a first processing unit 111, in which the image of the tooth surfaces represented by the image data and the processed position data of the bite fork are further processed to a (at least partial) coordinate-accurate image of the patient's teeth, wherein simultaneously a correlation with the image of the face surface of the patient can be made. Overall, in the first processing unit a set of data is acquired which enables coordinate-accurate pictorial representation of both dentition and face of the patient.

A tooth surface imprint acquired with the registration material in the bite fork 101 is processed in parallel in the traditional way, and the data obtained by this processing are entered by means of a correction data input unit 112 to verify the scanner and position data or is even used independently of the system described herein for other dental diagnostic purposes.

Another component of the system is constituted by a (known as such) paraocclusal spoon 113 with other position marker elements (not separately referred to), which is attached to the teeth of the mandible of the patient, such that it allows dentition movements and, in motion, continuously provides position data by way of its position markers. A second position detection unit 115 records and processes those position data recorded in motion, and a second processing unit 117 receives both the trajectory data acquired and the data series provided on the output side of the first processing unit and generates a moving image representation of the dentition and the patient's face, providing it to a output unit (which, in a manner known per se, may include a screen and other memory and processing means) for evaluation and analysis by a therapist.

The embodiment of the invention is not limited to these examples, but is also possible in a variety of modifications, which are within the scope of expert action.

1. A bite fork for check bite, especially with position marker elements for positioning in a positioning system, the bite fork having recesses on the contact surface for partial visualization of the tooth surfaces to a 3D surface scanner placed in the mouth cavity of a patient and markers which are detectable by this sensor.

2. The bite fork according to claim 1, comprising adjustment means for variably adjusting opening area of at least part of the recesses.

3. The bite fork according to claim 2, wherein the adjustment means comprise slidable ribs, which are designed such that they are able to connect an outer rim region and an inner rim region of the bite, fork to each other at various points of its extension.

4. The bite fork according to one claim 1, wherein at least a portion of the makers are designed as characteristic optically detectable or surface-shape-detectable positive casts or impressions or contrast markers, especially as a series of positive casts or impressions or contrast markers, preferably in a rim region for in both rim regions of the bite fork.

5. The bite fork according to claim 1, wherein at least a portion of the marker elements is designed as radiopaque elements, which are attached to or embedded in a base body of the bite fork.

6. The bite fork according to claim 1, comprising a check-bite part with first attachment means and a position marker part or sensor part with second attachment means matching the first attachment means, which is releasably connected to the check-bite part.

7. The bite fork according to claim 6, wherein the first and second attachment means comprise first and second contact surfaces which, in the connected state of the check-bite part and position marker part or sensor part, abut against each other, thus defining a predetermined 3D position of the position marker part or sensor part with respect to the bite marker part.

8. A check-bite part for forming a bite fork according to claim 6.

9. A position marker part or sensor part for forming a bite fork according to claim 6.

10. A check-bite kit for forming different bite forks according to claim 6, having at least one check-bite part, and at least one position marker part, and another position marker part or other accessory component with second attachment means matching the first attachment means.

11. A system for moving image representation of a dentition, comprising:
a bite fork according to claim 1, tooth surface detection means for providing an image of at least part of the tooth surfaces of the dentition,
first position detection elements matching the position marker elements of the bite fork for position detection of the bite fork in the state of being inserted in the mouth of an individual,
first processing means for correlating the image of the tooth surfaces and the position data of the bite fork for providing a spatial coordinate-accurate image of the tooth surfaces, one paraocclusal spoon to be attached to the teeth, having other position marker elements, second position detection means matching the further position marker elements for continuous position detection of the paraocclusal spoon during movements of the dentition and
second processing means for the creation of the moving image representation of the dentition according to the image of the tooth surfaces in accordance with the spatial coordinates and the time-dependent position data of the paraocclusal spoon,
wherein the first processing means are designed for processing a first image of tooth surfaces, detected in the mouth of the individual through the recesses of the bite fork and a second image of tooth surfaces acquired by way of impressions in the bite fork, especially in terms of correction processing of the first image and the second image.

12. The system of claim 11, wherein the tooth surface detecting means are realized by an intra-oral surface scanner.

13. The system according to claim 11, wherein said bite fork, especially in an outermost section of the mouth, comprises surface detecting means for providing an image of at least part of the face of the individual and the first processing means area also designed for correlation of the image of the face surface with the position data of the bite fork and for providing a spatial coordinate-accurate image and the second processing means are designed for providing a moving image representation of the face of the individual.

14. A method for displaying a dentition with a bite fork according to claim 1, comprising the detection of an image of tooth surfaces in the mouth of an individual, with bite fork being inserted, through the recesses of the bite fork, while simultaneously detecting markers of the bite fork and co-processing of the image of the tooth surfaces and images of the markers for acquiring calibrated image data of the tooth surfaces.

15. The method according to claim 14, comprising the detection of an additional image of tooth surfaces of the individual by way of detection of impressions in the registration material of the bite and combined processing of the images of the tooth surfaces and the impressions, especially as a correction processing.

16. The method according to claim 1, performed as a method for moving image representation, wherein
a position detection of the bite fork is done in the state of being inserted in the mouth of the individual, by way of first position detection means matching the position marker elements of the bite fork,
the image of the tooth surfaces and the position data of the bite fork are subjected to correlated processing for providing a spatial coordinate-accurate image of the tooth surfaces,
a continuous position detection of a paraocclusal spoon attached to the teeth of a patient, having further position marker is done by second position detection means matching said other position marker elements and
a moving image representation of the dentition is created in accordance with the spatial coordinates and the time-dependent position data of the paraocclusal spoon by way of second processing means.

17. The method of claim 16, wherein by way of face surface detecting means attached in an outermost section of the mouth an image of at least part of the face of the individual is detected and the image is correlated by way of said first processing means with the position data of the bite fork, thus creating a spatial coordinate-accurate image of the face surface of the individual and providing a moving image representation in the second processing means by way of position data acquired by the second position detection means.
